(19) United States
(12) Patent Application Publication
(10) Pub. No.: US 2015/0244697 A1
(43) Pub. Date: Aug. 27, 2015

(54) Method for Secure Servicing of a Field Device

(71) Applicant: ENDRESS+HAUSER FLOWTEC AG, Reinach (BL) (CH)

(72) Inventors: Sushil Siddesh, Basel (CH); Alain Chomik, Pulversheim (FR); Pierre Harnist, Bartenheim (FR)

(21) Appl. No.: 14/427,120

(22) PCT Filed: Aug. 28, 2013
(86) PCT No.: PCT/EP2013/067786

§ 371 Date: Mar. 10, 2015

(30) Foreign Application Priority Data
Sep. 20, 2012 (DE) 10 2012 108 866.7

(51) Int. Cl. H04L 29/06; H04L 29/08

(52) U.S. Cl. CPC H04L 63/08; H04L 67/02

(57) ABSTRACT

A method for secure servicing of a field device (FD) of process automation technology. The field device (FD) has a web server (WS), via which the field device (FD) can be serviced, wherein the field device (FD) has a function (CAPTCHA) for distinguishing computers from humans, wherein, upon an accessing of the field device (FD) via the web server (WS), the function (CAPTCHA) for distinguishing computers from humans is executed, in order to assure that the accessing of the field device (FD) is being done by a human user.

The invention relates to a method for secure servicing of a field device of process automation technology. Furthermore, the invention relates to a computer program product and to a field device of process automation technology.

Often applied in industrial plants are field devices, which serve for determining and/or monitoring process variables. The terminology, field device, includes, however, all process near, i.e. on-site, equipment used in a plant, such as, for example, gateways, manually operated devices and display devices. Field devices often have only a limited amount of resources for data management, data storage and data processing.

Known from the state of the art are field devices, which utilize web servers, via which the respective field devices can be serviced. In order to enable data transmission from the web server to a display- and/or servicing device, the field device utilizes a communication interface, via which a communication connection with the web server can be established. Such interfaces can be embodied, for example, according to an IEEE 802.3 standard, for example, for Ethernet/IP, ProfiNet, ModBus (in the Ethernet mode) communication, all of which fall under the generic label, Ethernet.

Since such field devices equipped with an Ethernet interface are also combinable to networks and are being used more and more, there comes the danger of unauthenticated, respectively unauthorized, respectively unverified access, thus the danger of a so-called cyber-attack for these field devices equipped with Ethernet technology, respectively for the plants, in which these fields devices are installed.

Such cyber-attacks are known in the case of the Internet, especially the WWW, and are described, for example, in Offenlegungsschrift EP 2383954 A2 and Offenlegungsschrift U.S. 20120047257 A1.

In order, for example, to distinguish computers from humans, it is known from the state of the art to make use of so-called CAPTCHAs. Use of a CAPTCHA can effectively prevent the accessing of a web server by bots or botnets.

Since a cyber-attack can, in given cases, lead to a failure or shutdown of a plant, in which the field devices are installed, such attacks must be avoided or their consequences minimized.

Known from the state of the art, furthermore, is to provide for accessing a web server via the Internet a so-called CAPTCHA server, which is likewise connected via the Internet with the web server, and which serves to provide the web server with the CAPTCHA. Such CAPTCHA servers are currently operated by service providers, which provide presumably secure CAPTCHA functions. These CAPTCHA servers require, however, more resources in terms of memory capacity and energy consumption, for example, extensive databases, than are available, for example, in an industrial plant at the fieldbus level or in a field device. Furthermore, an industrial plant, respectively a field device is, in given cases, not even connected with the Internet.

An object of the invention is, thus, to provide a plant, especially a field device, which is secure against cyber-attacks, especially DDoS attacks.

The object is achieved according to the invention by a method, a computer program product and a field device.

As regards method, the object is achieved by a method for secure servicing of a field device of process automation technology, wherein the field device has a web server, via which the field device can be serviced, wherein the field device has a function for distinguishing computers from humans, wherein, upon an accessing of the field device via the web server, the function for distinguishing computers from humans is executed, in order to assure that the accessing of the field device is being done by a human user.

In a form of embodiment of the method, the function for distinguishing computers from humans is furnished in a memory unit of the field device.

In an additional form of embodiment of the method, the function for distinguishing computers from humans is executed by a computing unit of the field device.

In an additional form of embodiment of the method, the web server is integrated into the field device.

In an additional form of embodiment of the method, the computing unit is an operating electronics of the field device, preferably a so-called embedded system, which serves for performing the functions, respectively functionalities, of the field device.

In an additional form of embodiment of the method, the accessing of the field device by means of the web server occurs via an Ethernet connection, preferably a point-to-point connection. Furthermore, the accessing of the web server of the field device can occur via an intranet connection, wherein at least the field device as well as also the servicing device, in which a client-application is executed, which enables the accessing of the web server by the servicing device, are part of the intranet.

In an additional form of embodiment of the method, the field device includes a function for authentication of a user. Especially, this function includes a username and/or password query, which is executed upon an accessing of the field device via the web server.

In an additional form of embodiment of the method, the verification of a user is performed by the function for distinguishing computers from humans, before the authentication of the user by the function for authentication.

In an additional form of embodiment of the method, the authentication of a user is performed by the function for authentication and the verification of the user is performed simultaneously by the function for distinguishing computers from humans, preferably on the same form presented in a display of a service unit, via which the accessing of the field device occurs.

In an additional form of embodiment of the method, the web server provides a user with field device information.

In an additional form of embodiment of the method, the field device has, at least at the point in time of the accessing of the web server, no Internet connection.

In an additional form of embodiment of the method, the function for distinguishing computers from humans involves a so-called CAPTCHA.

In an additional form of embodiment of the method, the function for distinguishing computers from humans includes a first subfunction, by means of which a pseudo-random number is produced.

In an additional form of embodiment of the method, the function for distinguishing computers from humans includes a second subfunction, which serves for distorted display of an object.

In an additional form of embodiment of the method, the accessing of the web server of the field device, especially of the authentication function, is, at least at times, denied, in case the verification of a human user by the function for distinguishing computers from humans was not successful a predetermined number of times.

In an additional form of embodiment of the method, the accessing of field device information, which are transmitted via the web server of the field device, is permitted, in case the verification of a human user by the function for distinguishing computers from humans was successful.

As regards computer program product, the object is achieved by a computer program product having program code means, which, when they are executed, serve for performing the method according to one of the preceding forms of embodiment. For example, the computer program product can be a software, which includes, for example, a web server, a client application for the web server and/or a function, such as, for example, a CAPTCHA server, for distinguishing computers from humans. The program code means can comprise a programming- and/or script language.

As regards field device, the object is achieved by a field device of process automation technology, wherein integrated into the field device is a web server, which serves for servicing the field device, wherein the field device has a function for distinguishing computers from humans, which serves to detect whether, in an accessing of the field device via the web server, the accessing of the field device is being done by a human user.

The invention will now be explained in greater detail based on the appended drawing, the figures of which show as follows:

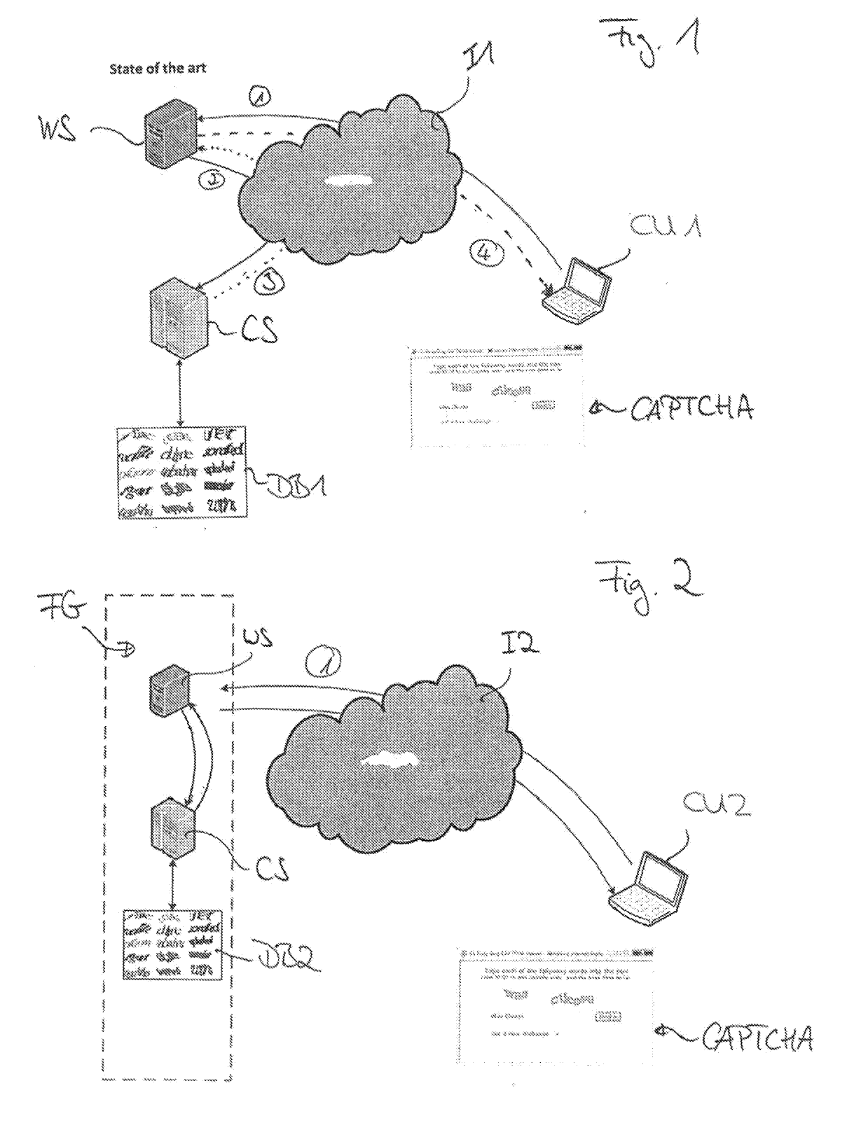

FIG. 1 a CAPTCHA query according to the state of the art,

FIG. 2 a schematic representation of a form of embodiment of the invention, in the case of which a CAPTCHA-function is integrated into a field device,

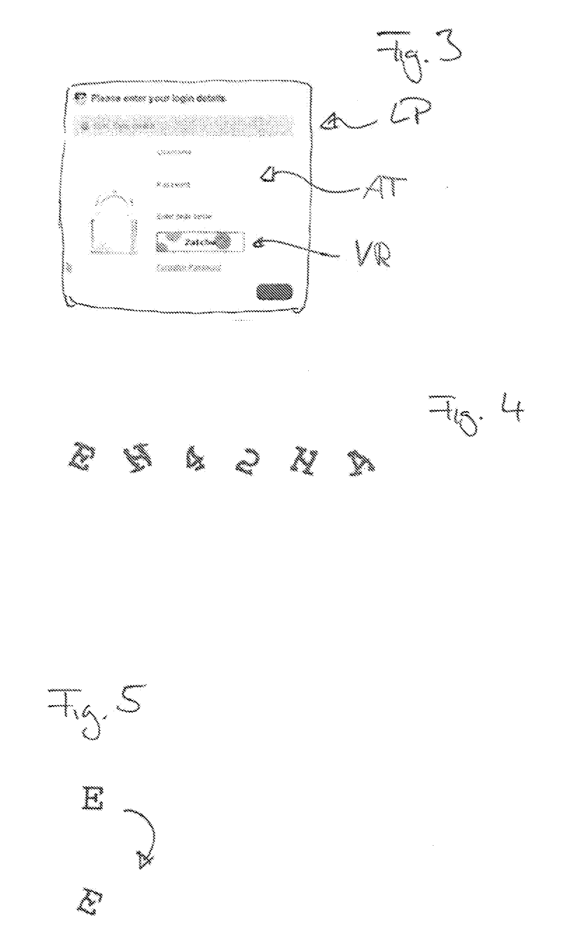

FIG. 3 a login page for accessing a web server of a field device according to a form of embodiment of the invention,

FIG. 4 a CAPTCHA according to a form of embodiment of the invention,

FIG. 5 a formatting of a character according to a form of embodiment of the invention.

FIG. 1 shows a web server WS, a CAPTCHA server CS and a computing unit CU1, which are connected with one another via the Internet T1. Executed in the computing unit can be, for example, a client application, which enables accessing of the computer, in which the web server WS is executed. Via this client application, a user can retrieve data, such as, for example, field device information, from the web server WS. In order to establish a connection with the web server WS, a corresponding request 1 is sent to the web server WS. In order to verify that the request 1 is from a human and not a computer, before accessing the web server WS by the computing unit CU1 is permitted, a CAPTCHA query is performed. To this end, the web server WS sends, likewise via the Internet I1, a request 2 to a CAPTCHA server CS, the CAPTCHA server creates a CAPTCHA or retrieves a CAPTCHA from a database DB1 and sends the CAPTCHA as response 3 to the request 2 to the web server WS1. The CAPTCHA is then sent by the web server WS via the Internet I1 as response 4 to the request 1 to the computing unit CU1 and shown on a graphical user interface, so that the user can supply a corresponding input for satisfying the CAPTCHA query.

Upon receiving a request (from a client application in a servicing device) for an http page, the web server WS1 contacts the CAPTCHA server CS. The CAPTCHA server CS is usually arranged at another physical location than the web server. Furthermore, the CAPTCHA server CS usually also has another IP address than the web server WS. The CAPTCHA server CS serves to present to a user a riddle, which the user must solve, and to determine whether the solution provided by the user is correct. The question or problem posed to the user can be the resolving of a distorted picture, the answering of a (trivial) question and/or the solution to a mathematical problem.

In an industrial environment, often no Internet connection is available.

FIG. 2 shows a schematic representation of a form of embodiment of the proposed invention, in the case of which a CAPTCHA-function CS is integrated into a field device FD. The field device FD in FIG. 2 includes a web server WS, via which settings can be made in the field device FD, thus via which the field device FD can be serviced. Additionally to the web server WS, a CAPTCHA server CS is integrated into the field device FD. Instead of the CAPTCHA server, there can be integrated into the field device FD and/or the web server WS simply a corresponding function, which, when it is invoked, produces and/or provides a CAPTCHA.

For producing and/or providing a CAPTCHA, such as in the example of an embodiment according to FIG. 2, a database DB2 can be provided in the field device. Stored in the database can be, for example, CAPTCHAs or information, such as, for example, pictures, which serve for creating a CAPTCHA.

The field device FD is connected in the example of an embodiment in FIG. 2 via a network in the form an intranet 12 with a servicing device CU2 in the form of a computing unit. The field device FD can, however, also be connected directly with a servicing device FD. Furthermore, the servicing device CU2 can, instead of the computing unit CU2 shown in FIG. 2 in the form of a laptops, also be a PC, i.e. a personnel computer, a handheld servicing device, such as, for example, the FieldXpert handheld servicing device sold by the applicant, or a mobile device, such as, for example, a smart phone or a tablet.

If now the servicing device CU2 requests interaction with the web server WS2, then, as response to the demand for verification, whether the request is from a human user, a CAPTCHA is sent to the servicing device CU2 and there preferably shown on a user interface of the service device CU2.

Following receipt of the request 1 by the web server WS, a function for distinguishing computers from humans is invoked and sent as response to the servicing device CU2.

Via the servicing device CU2, a user can process and solve the CAPTCHA and obtain access to the web server WS.

The web server WS and the function for distinguishing between computers and humans can, in such case, be integrated into the field device FD, i.e. embedded in the field device FD and form a so-called embedded system.

The shown forms of embodiment of a CAPTCHA in the form of distorted pictures, more exactly distorted texts, respectively text elements, can, however, be replaced or supplemented by other CAPTCHAs, especially the above-mentioned riddles, such as, for example, a mathematical problem.

FIG. 3 shows a login page for accessing a web server WS of a field device FD according to a form of embodiment of the proposed invention, especially FIG. 3 shows the first accessing of a session with the web server. For authentication by the web server WS, a user can be provided a login page LG for input of a username and password. The user authenticates itself using its username and password, whereupon the web server authorizes the user, especially as a function of the username and/or password, to utilize certain field device functions provided by the web server WS or to retrieve field device information. Additionally to authentication, it can be verified whether the user is a human or a computer. To this end, a CAPTCHA can be utilized, which must be solved by the user. The CAPTCHA can, in such case, be presented before the authentication, respectively authentication of the user. The CAPTCHA can, however, also, such as shown in FIG. 3, be shown on the login page simultaneously with the inputs for authentication of the user, so that only when the user has correctly input both username and password as well as also the CAPTCHA does the authentication and, in given cases, the authorizing by the web server occur.

In this way, so-called “brute force” attacks, in the case of which usernames and/or passwords of a large number of usernames and/or passwords are tried out, can be defended against.

The CAPTCHA can, in such case, be produced essentially by performing two subfunctions, namely a first subfunction for (pseudo-) random number production and a second subfunction for producing distorted pictures.

FIG. 4 shows a possible CAPTCHA a user must solve, in order to obtain access to the web server WS of the field device FD.

The function for distinguishing computers from humans can be a CAPTCHA, for example, which is produced as follows:

From a number of alphanumeric characters, which are present in the form of pictures, by producing random numbers, those pictures are selected, which are associated with the produced random numbers. For example, a string of the six letters, “EN42HA”, can be produced in such a manner. These characters can be individually distorted or distorted as an entire string. The distorted picture, respectively the distorted pictures, are then provided, for example, by the CAPTCHA server CS to the web server WS. The CAPTCHA to be solved, as presented to the user, is shown in FIG. 4.

Instead of the function for distortion of selected pictures, also already distorted pictures stored in the field device can be used, which are then selected, for example, by an algorithm using random numbers. These pictures can be downloaded from the database DB2.

FIG. 5 shows the formatting of a character “E” according to another form of embodiment of the proposed invention. Used as format for pictures stored in the field device FD can be, for example, the bitmap format. For example, the letter “E” can be stored in the already distorted shape illustrated in FIG. 5. Alternatively, the pictures can be stored in non-distorted shape and the distorted pictures produced, i.e. they are distorted, first during the runtime, for example, before they are sent to the web server.

The distortions can be achieved in different ways. For example, the starting pictures can be helically distorted, tilted and/or translationally displaced, so that they overlap with other pictures. These selected transformations are performable especially by a low power microprocessor of the kind often used in a field device. The proposed function for distinguishing computers from humans can, in such case, essentially be based on methods selected from the mentioned transformations, so that little need for memory capacity and energy consumption is present and, thus, the function can be implemented in a field device ED.

### LIST OF REFERENCE CHARACTERS

WS web server
CS CAPTCHA server
DB1 first database
DB2 second database
1 request from a client application to the web server
2 request from the web server to the CAPTCHA server
3 response of the CAPTCHA server to the web server
4 response of the web server to the client application
I1 Internet
I2 intranet
CU1 first computing unit
CU2 second computing unit
FD field device
LP login page (for the web server)
AT user authentication
VR user verification
CAPTCHA function for distinguishing computers from humans

1-18. (canceled)

19. A method for secure servicing of a field device of process automation technology, comprising:
providing a field device with a web server, via which the field device can be serviced;
providing the field device with a function (CAPTCHA) for distinguishing computers from humans; and
upon an accessing of the field device via the web server, the function (CAPTCHA) for distinguishing computers from humans is executed, in order to assure that the accessing of the field device is being done by a human user.

20. The method as claimed in claim 19, wherein:
the function (CAPTCHA) for distinguishing computers from humans is furnished in a memory unit of the field device.

21. The method as claimed in claim 19, wherein:
the function (CAPTCHA) for distinguishing computers from humans is executed by a computing unit of the field device.

22. The method as claimed in claim 19, wherein:
the web server is integrated into the field device.

23. The method as claimed in claim 19, wherein:
the computing unit is an operating electronics of the field device, a so-called embedded system, which serves for performing the functions, respectively functionalities, of the field device.

24. The method as claimed in claim 19, wherein:
the accessing of the field device by means of the web server occurs via an Ethernet connection, a point-to-point connection.

25. The method as claimed in claim 19, wherein:
the field device includes a function for authentication of a user, especially has a username and/or password query, which is executed upon an accessing of the field device via the web server.

26. The method as claimed in claim 19, wherein:
the verification of user is performed by the function (CAPTCHA) for distinguishing computers from humans, before the authentication of the user by the function for authentication.

27. The method as claimed in claim 19, wherein:
the authentication of a user is performed by the function for authentication and the verification of the user is performed simultaneously by the function (CAPTCHA) for distinguishing computers from humans, on the same form presented in a display of a service unit, via which the accessing of the field device occurs.

28. The method as claimed in claim 19, wherein:
the web server provides a user with field device information.

29. The method as claimed in claim 19, wherein:
the field device has, at least at the point in time of the accessing of the web server, no Internet connection.

30. The method as claimed in claim 19, wherein:
the function for distinguishing computers from humans around is a so-called CAPTCHA.

31. The method as claimed in claim 19, wherein:
the function (CAPTCHA) for distinguishing computers from humans includes a first subfunction, by means of which a pseudo-random number is produced.

32. The method as claimed in claim 19, wherein:
the function (CAPTCHA) for distinguishing computers from humans includes a second subfunction, which serves for distorted display of an object.

33. The method as claimed in claim 19, wherein:
the accessing of the web server of the field device, especially of the authentication function, is, at least at times, denied, in case the verification of a human user by the function for distinguishing computers from humans was not successful a predetermined number of times.

34. The method as claimed in claim 19, wherein:
the accessing of field device information, which are sent via the web server of the field device, is permitted, in case the verification of a human user by the function for distinguishing computers from humans was successful.

35. A computer program product having program code means, which, when they are executed, serve for performing the method as claimed, as defined in claim 19.

36. A field device of process automation technology, wherein:
integrated in the field device is a web server, which serves for servicing the field device;
the field device has a function for distinguishing computers from humans, which serves to detect whether in an accessing of the field device via the web server the accessing of the field device is being done by a human user.
